(19) United States
(12) Patent Application Publication
(10) Pub. No.: US 2026/0011986 A1
(43) Pub. Date: Jan. 8, 2026

(54) FLOOR-TO-CEILING PILLAR

(71) Applicant: DONGGUAN JIASHENG LIGHTING TECHNOLOGY CO., LTD., Dongguan (CN)

(72) Inventor: CHIH-PIN HSU, Dongguan (CN)

(21) Appl. No.: 18/803,628

(22) Filed: Aug. 13, 2024

(30) Foreign Application Priority Data
Jul. 5, 2024 (CN) 202421595727.4

(51) Int. Cl. H02B 1/01; A47B 45/00; A47B 49/00; A47B 57/06

(52) U.S. Cl. CPC H02B 1/012; A47B 45/00; A47B 49/004; A47B 57/06; A47B 2220/0091

(57) ABSTRACT

Disclosed is a floor-to-ceiling pillar, including a main body, an upper adjusting rod and a lower adjusting rod respectively sleeved inside both ends of the main body. The main body includes a pole body and electrified assemblies. The upper adjusting rod and the lower adjusting rod are respectively sleeved inside both ends of the pole body, to fix the floor-to-ceiling pillar through the upper adjusting rod and the lower adjusting rod. The electrified assemblies are sleeved on the pole body, and are capable of sliding along the pole body and are rotatably arranged around the pole body. The assemblies are electrically connected to power supplies to supply power to the power-consuming parts on the electrified assemblies. The present disclosure achieves the functions of storage, illuminating, charging, and power supply at different heights and orientations only in a small space.

### TECHNICAL FIELD

The present disclosure relates to the technical field of furniture for hanging or placing items, and particularly relates to a floor-to-ceiling pillar.

### BACKGROUND

In real life, different types of shelves, cabinets and other furniture are needed to hang or place various miscellaneous items, to achieve the classified placement and storage of various items. However, due to space limitations in specific scenarios, it is difficult to place conventional shelves or cabinets, thus requiring specific designs to achieve the function of hanging or placing items. In the prior art, floor-to-ceiling pillars (heaven and earth columns) can be widely applied in different scenarios due to occupation of small spaces. Therefore, they are commonly used for hanging or placing items for the purpose of display or exhibition.

However, floor-to-ceiling pillars in the prior art usually achieve the function of hanging or placing items only through hooks or pallets fixed on pillar bodies, and cannot supply corresponding power to common lighting fixtures or appliances, i.e., only power cords equipped for the lighting fixtures or appliances can be connected to external power supplies for supplying power. Therefore, although the floor-to-ceiling pillars in the prior art are capable of improving space utilization, they have single functions and are particularly incapable of achieving functions of illuminating, power supply and the like.

Thus, the prior art is required to be further improved and developed.

### SUMMARY

In view of the defects in the prior art, the present disclosure provides a floor-to-ceiling pillar, to solve the problem that floor-to-ceiling pillars in the prior art have single functions and can only be used for hanging or placing items.

The technical solution of the present disclosure is as follows:

A floor-to-ceiling pillar, including a main body, an upper adjusting rod and a lower adjusting rod respectively sleeved inside both ends of the main body, where the main body includes:
a pole body, where the upper adjusting rod and the lower adjusting rod are respectively sleeved inside both ends of the pole bod to fix the floor-to-ceiling pillar through the upper adjusting rod and the lower adjusting rod; and
electrified assemblies, where the electrified assemblies are sleeved on the pole body, and are capable of sliding along the pole body and are rotatably arranged around the pole body, and the assemblies are electrically connected to power supplies to supply power to the power-consuming parts on the electrified assemblies.

In an implementation, a conductor rail is arranged in a way of extending in an axial direction of the pole body, and the corresponding electrified assembly is electrically connected to the power supply through the conductor rail to supply power to the power-consuming part.

In an implementation, each of the electrified assemblies includes:
a sliding part, where the sliding part is sleeved on the pole body, and each of the electrified assemblies slides along the pole body through the sliding part;
a rotating part, where the rotating part is sleeved on an outer side of the sliding part, and each of the electrified assemblies rotates around the pole body through the rotating part;
a conductive part, where one end of the conductive part is arranged on a side of the sliding part facing the pole body and abuts against the conductor rail, and the other end of the conductive part is electrically connected to the power-consuming part; and
the power-consuming part, where the power-consuming part is fixedly connected to the rotating part, and the power-consuming part is electrically connected to the conductor rail through the conductive part.

In an implementation, the conductive part includes:
a fixed convex contactor, where the fixed convex contactor is fixed on a side of the sliding part facing the pole body and abuts against the conductor rail;
a conductive wire, where the conductive wire is fixed on the sliding part, one end of the conductive wire is connected to the fixed convex contactor, and the other end of the conductive wire passes through the sliding part and surrounds the outer side of the sliding part by one circle to form an annular structure; and
a movable convex contactor, where the movable convex contactor is fixed inside the rotating part, and when the rotating part rotates, one end of the movable convex contactor maintains abutment with the annular structure formed by the conductive wire, and the other end of the movable convex contactor is electrically connected to the power-consuming part.

In an implementation, the conductive part further includes:
a conductive compression spring, where the conductive compression spring is fixed inside the power-consuming part, one end of the conductive compression spring abuts against the movable convex contactor to ensure that the movable convex contactor abuts against the conductive wire, and the other end of the conductive compression spring is connected to the power-consuming part to achieve an electrical connection between the movable convex contactor and the power-consuming part.

In an implementation, the power-consuming part is pivotally connected to the rotating part, and a pivot is horizontally arranged such that the power-consuming part is capable of rotating relative to the rotating part in a vertical plane.

In an implementation, a clamping tooth is formed at a position of the rotating part facing the power-consuming part, a plurality of clamping tooth grooves corresponding to the clamping tooth are formed on the power-consuming part, and the clamping tooth grooves are meshed with the clamping tooth, to control an angle of the power-consuming part relative to the rotating part in the vertical plane.

In an implementation, a conductive groove is formed on a surface of the pole body in a way of extending in an axial direction, and the conductor rail is fixed at a bottom of the conductive groove; and

in correspondence with the conductive groove, a boss is arranged on an inner side of the sliding part of each of the electrified assemblies corresponding to the conductive groove, and the boss is clamped inside the conductive groove, to ensure that the sliding part and the pole body do not rotate relative to each other when each of the electrified assemblies slides along the pole body.

In an implementation, a locking groove is further formed on the surface of the pole body in a way of extending in the axial direction; and
each of the electrified assemblies further includes a locking part, and the locking part is sleeved on the pole body and cooperates with the locking groove, such that each of the electrified assemblies slides along the pole body or each of the electrified assemblies is fixed on the pole body.

In an implementation, the locking groove is provided with a first locking position and a second locking position in a circumferential direction of the pole body, and a depth of the second locking position is less than a depth of the first locking position; and
the locking part is arranged below the rotating part and is capable of rotating around the pole body, and a clamping protrusion is arranged on an inner side of the locking part corresponding to the locking groove, when the clamping protrusion is located at the first locking position, the electrified assemblies are capable of sliding along the pole body, and when the locking part rotates to cause the clamping protrusion to be located at the second locking position, the electrified assemblies are fixed on the pole body.

In an implementation, the main body further includes length regulators, and the length regulators are sleeved on the main body and respectively arranged at the intersections between one end of the main body and the upper adjusting rod and between the other end of the main body and the lower adjusting rod, such that lengths of the upper adjusting rod and the lower adjusting rod extending from the main body can be adjusted.

In an implementation, a plurality of inserting holes are axially formed on a side of the upper adjusting rod and the lower adjusting rod respectively at a fixed interval, and each of the length regulators includes:
a clamping part, where the clamping part is arranged to correspond to the inserting hole, and when the clamping part is clamped with the inserting hole, positions of the upper adjusting rod and the lower adjusting rod are fixed; and
a pressing part, where the pressing part is fixedly connected to the clamping part and arranged on opposite sides of the main body respectively, when the pressing part is pressed, the clamping part is detached from the inserting hole, and when the pressing part is released, the clamping part rebounds and is clamped with the inserting hole.

In an implementation, the lower adjusting rod includes:
a lower adjusting rod body, where the lower adjusting rod body is sleeved inside the main body, and a length of the lower adjusting rod body extending from the main body is adjusted by one corresponding length regulator;
an abutment plate, where the abutment plate is arranged at a bottom of the lower adjusting rod, to cause the floor-to-ceiling pillar to be better secured on a floor; and
a tensioning device, where one end of the tensioning device abuts against the abutment plate, and the other end the tensioning device is in threaded connection with the lower adjusting rod body, such that a thread distance between the tensioning device and the lower adjusting rod body can be adjusted by rotating the tensioning device, and the length of the lower adjusting rod extending from the main body can be further adjusted.

In an implementation, an electrifying part is arranged on the length regulator at the intersection between the lower adjusting rod and the main body, and the electrifying part includes:
conductive sheets, where one end of each of the conductive sheets abuts against the conductor rail; and
a power connector, where the power connector is connected to a power cord and electrically connected to the power supply, the other end of each of the conductive sheets is fixed on one corresponding length regulator, and the power connector transfers received power to the conductor rail through the conductive sheets, to supply power to the electrified assemblies.

Compared with the prior art, the present disclosure provides a floor-to-ceiling pillar. The floor-to-ceiling pillar includes a main body, an upper adjusting rod and a lower adjusting rod respectively sleeved inside both ends of the main body. The main body includes a pole body and electrified assemblies. The upper adjusting rod and the lower adjusting rod are respectively sleeved inside both ends of the pole body, to fix the floor-to-ceiling pillar through the upper adjusting rod and the lower adjusting rod. The electrified assemblies are sleeved on the pole body, and are capable of sliding along the pole body and are rotatably arranged around the pole body. The assemblies are electrically connected to power supplies to supply power to the power-consuming parts on the electrified assemblies. Through the arrangement of the electrified assemblies on the pole body capable of sliding freely along the pole body, in combination with the power-consuming part inside the electrified assembly, the present disclosure is capable of achieving the functions of storage, illuminating, charging, and power supply only in a small space without the need for separate power cords, which improves the aesthetics of storage. Further, height positions and orientation angles of the electrified assemblies can be adjusted freely, which further optimizes the space utilization and achieves diverse functions, such that it is more conducive to market promotion.

### BRIEF DESCRIPTION OF THE DRAWINGS

FIG. 1 is a space diagram of a floor-to-ceiling pillar in an implementation of the present disclosure.

FIG. 2 is a front view of a main body of a floor-to-ceiling pillar in an implementation of the present disclosure.

FIG. 3 is a partial sectional view of an electrified assembly sleeved on a pole body of a floor-to-ceiling pillar in an implementation of the present disclosure.

FIG. 4 is a top view of an electrified assembly sleeved on a pole body of a floor-to-ceiling pillar in an implementation of the present disclosure.

FIG. 5 is a partial sectional view of an electrified assembly of a floor-to-ceiling pillar in an implementation of the present disclosure.

FIG. 6 is an exploded view of an electrified assembly of a floor-to-ceiling pillar in an implementation of the present disclosure.

FIG. 7 is an exploded view of an electrified assembly of a floor-to-ceiling pillar in another implementation of the present disclosure.

FIG. 8 is a top view of a locking part of an electrified assembly sleeved on a pole body of a floor-to-ceiling pillar in an implementation of the present disclosure.

FIG. 9 is a schematic diagram of a lower adjusting rod extending from a main body of a floor-to-ceiling pillar in an implementation of the present disclosure.

FIG. 10 is a schematic diagram of further adjusting a length of a lower adjusting rod extending from a main body of a floor-to-ceiling pillar in an implementation of the present disclosure.

FIG. 11 is a sectional view of a state of clamping between a length regulator and an inserting hole of a floor-to-ceiling pillar in an implementation of the present disclosure.

FIG. 12 is a sectional view of a length regulator detached from an inserting hole of a floor-to-ceiling pillar in an implementation of the present disclosure.

FIG. 13 is an exploded view of a length regulator of a floor-to-ceiling pillar in an implementation of the present disclosure.

### DETAILED DESCRIPTIONS OF THE EMBODIMENTS

The present disclosure provides a floor-to-ceiling pillar. In order to make objectives, technical solutions and effects of the present disclosure clearer and more explicit, the present disclosure will be further described in detail below. It should be understood that specific embodiments described herein are merely used to explain the present disclosure, and are not used to limit the present disclosure.

It should be noted that the terms “center”, “upper”, “lower”, “left”, “right”, “inside”, “outside”, “vertical”, “horizontal”, and the like indicate azimuthal or positional relations based on those shown in the drawings only for ease of description of the present disclosure and for simplicity of description, and are not intended to indicate or imply that the referenced structure must have a particular orientation and be constructed in a particular orientation, and thus may not be construed as a limitation on the present disclosure.

Unless articles are specially defined herein, “a/an” and “the” can refer to one or more in general. In the description of the embodiments of the present disclosure, the terms such as “first” and “second” are for descriptive purposes only and are not to be construed as indicating or implying their relative importance or implicitly specifying the number of indicated technical features. Thus, a feature defined with “first” and “second” may explicitly or implicitly include at least one of the features. Further, the technical solutions between various embodiments of the present disclosure may be combined with one another on the basis that they may be implemented by those of ordinary skill in the art. When leading to contradiction or failing in implementation, the combination between the technical solutions should be deemed non-existent, and falls outside the scope of protection of the present disclosure.

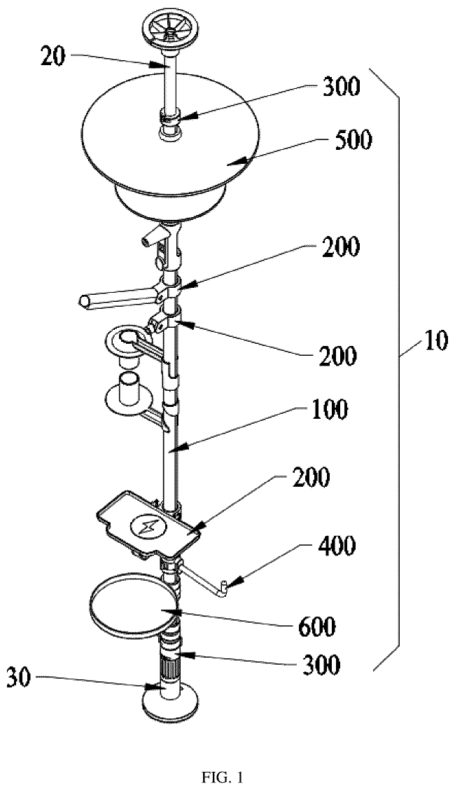

The present disclosure provides a floor-to-ceiling pillar. As shown in FIG. 1, the floor-to-ceiling pillar includes a main body 10, an upper adjusting rod 20, and a lower adjusting rod 30, where the upper adjusting rod 20 and the lower adjusting rod 30 are respectively sleeved inside both ends of the main body 10, and the upper adjusting rod 20 and the lower adjusting rod 30 are capable of extending or retracting from the main body 10 to adjust a height of the floor-to-ceiling pillar, such that the floor-to-ceiling pillar may be fixed at different heights. Specifically, a length regulator 300 is arranged at an intersection between the main body 10 and the upper adjusting rod 20 and between the main body 10 and the lower adjusting rod 30, respectively, to adjust lengths of the upper adjusting rod 20 and the lower adjusting rod 30 extending from the main body 10, such that the floor-to-ceiling pillar is fixed at different heights.

Optionally, a plurality of inserting holes are axially formed on a side of the upper adjusting rod 20 and the lower adjusting rod 30 respectively at a fixed interval, the length regulator 300 is provided with a buckle, and the buckles are detached from the corresponding inserting holes to cause the upper adjusting rod 20 and the lower adjusting rod 30 to freely extend or retract in the main body 10. The buckles are clamped into corresponding boyonets to fix extension lengths of the upper adjusting rod 20 and the lower adjusting rod 30 relative to the main body 10. The length regulators 300 are arranged to cause the upper adjusting rod 20 and the lower adjusting rod 30 to freely extend or retract in the main body 10 and fix the upper adjusting rod 20 and the lower adjusting rod 30 relative to the main body 10, so as to achieve control over an overall height of the floor-to-ceiling pillar of the present disclosure.

Further, a tensioning device is arranged on the upper adjusting rod 20 or the lower adjusting rod 30, to provide tension between the main body 10 and the upper adjusting rod 20/the lower adjusting rod 30, so as to ensure the floor-to-ceiling pillar is fixed between a floor and a ceiling with a determined height. Optionally, an abutment plate is arranged at a top end of the upper adjusting rod 20 and a bottom end of the lower adjusting rod 30 respectively, to ensure abutment of the upper adjusting rod 20 with the ceiling, and the abutment of the lower adjusting rod 30 with the floor, which increases the friction between the floor-to-ceiling pillar and both the ceiling and the floor, thus better fixing the floor-to-ceiling pillar.

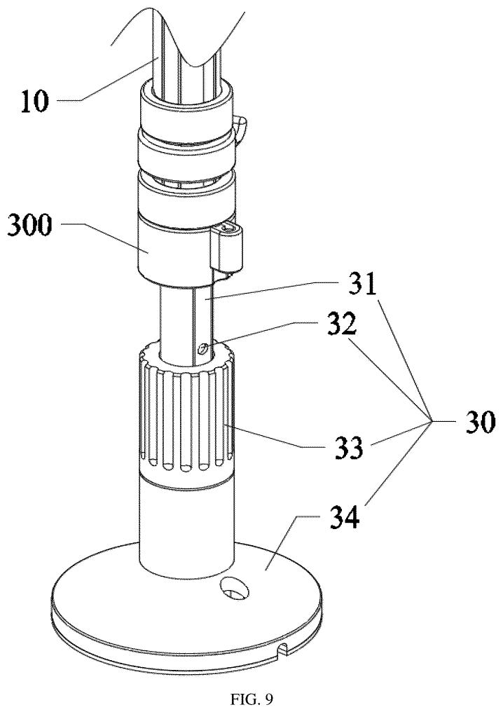

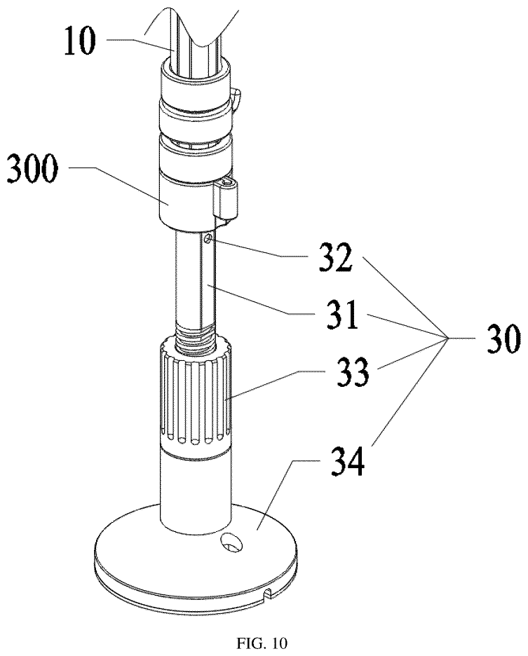

Specifically, as shown in FIG. 9, the lower adjusting rod 30 includes a lower adjusting rod body 31, inserting holes 32, a tensioning device 33, and an abutment plate 34. The abutment plate 34 is configured to have a conical structure to increase an area of contact with the floor and facilitate fixed arrangement of the floor-to-ceiling pillar on the floor. The lower adjusting rod body 31 is sleeved inside the main body 10, and a plurality of the inserting holes 32 are axially formed on the lower adjusting rod body 31 at a fixed interval. Through the length regulator 300 and the inserting holes 32 that match each other, the control over the length of the lower adjusting rod body 31 extending from the main body 10 is achieved. Further, one end of the tensioning device 33 abuts against the abutment plate 34, and the other end of the tensioning device 33 is in threaded connection with an end of the lower adjusting rod body 31 extending from the main body 10. As shown in FIG. 10, by rotating the tensioning device 33, a position of the tensioning device 33 on the thread of the lower adjusting rod body 31 can be adjusted, such that a thread distance between the tensioning device 33 and the lower adjusting rod body 31 can be adjusted, and the length of the lower adjusting rod 30 extending from the main body 10 can be further adjusted on this basis. Through the inserting holes 32 and the length regulator 300 that match each other, the length of the lower adjusting rod 30 extending from the main body 10 is adjusted at a large scale. Then, based on the thread distance between the tensioning device 33 and the lower adjusting rod body 31, the length of the lower adjusting rod 30 extending from the main body 10 is adjusted at a small scale, to ensure that the length of the lower adjusting rod 30 extending from the main body 10 can be accurately adjusted in any environment, such that the height of the floor-to-ceiling pillar can accurately match the current environment, which is conducive to the application of the floor-to-ceiling pillar in different scenarios.

In an embodiment, the upper adjusting rod 20 is arranged similarly to the lower adjusting rod 30, but a corresponding tensioning device is not arranged. Further, the inserting holes on the upper adjusting rod 20 are distributed more densely, i.e., a spacing between adjacent inserting holes thereon is smaller than the spacing between adjacent inserting holes on the lower adjusting rod 30, such that the length of the upper adjusting rod 20 extending from the main body 10 can be adjusted in a more precise manner.

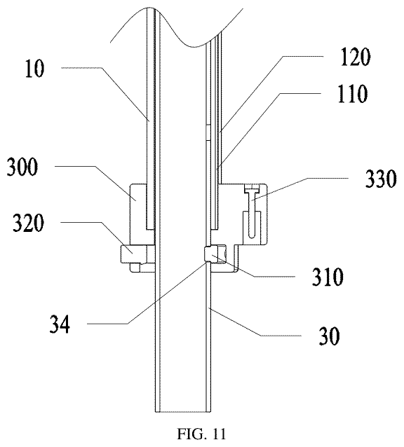

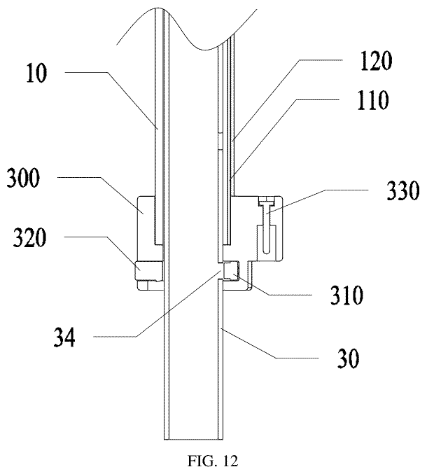

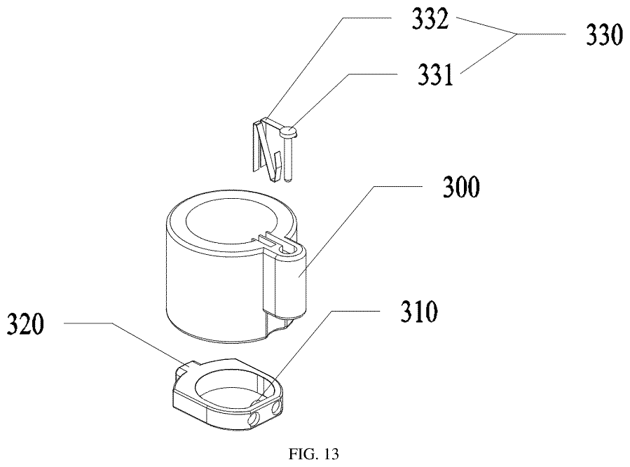

Further, as shown in FIGS. 11 and 13, the length regulator 300 includes a clamping part 310 and a pressing part 320 fixedly connected to the clamping part 310, where the clamping part 310 and the pressing part 320 are located around the main body 10 and are further symmetrically arranged relative to the main body 10. Specifically, the length regulator 300 is sleeved at an intersection between the main body 10 and the lower adjusting rod 30 or the upper adjusting rod 20. Taking the lower adjusting rod 30 as an example, the clamping part 310 is a clamping protrusion formed by that an inner side of the length regulator 300 protrudes towards the main body 10 and the lower adjusting rod 30. Further, the clamping part 310 is arranged to correspond to the inserting hole 32, i.e., the clamping part 310 matches the inserting hole 32 in size, and the clamping part 310 can extend into the inserting hole 32 for clamping with the inserting hole 32. As shown in FIG. 12, when the pressing part 320 is pressed, the clamping part 310 is detached from the inserting hole 32, and the lower adjusting rod 30 is capable of freely extending or retracting in a manner relative to the main body 10, such that the length of the lower adjusting rod 30 extending from the main body 10 can be adjusted. When the pressing part 320 is released, the clamping part 310 extends into the inserting hole 32 for clamping with the inserting hole 32, and the length of the lower adjusting rod 30 extending from the main body 10 is fixed, such that the height of the floor-to-ceiling pillar is fixed. The arrangement of the upper adjusting rod 20 is the same as that of the lower adjusting rod 30 and will not be repeated here.

Optionally, a rebound device is further arranged on the length regulator 300, and the rebound device continuously provides a force for the clamping part 310 to move towards the main body 10, to ensure that when the pressing part 320 is released, the clamping part 310 moves towards the main body 10 and is clamped into a corresponding inserting hole. In the present disclosure, through the length regulator 300 and the inserting holes on the upper adjusting rod 20 and the lower adjusting rod 30 that match each other, the lengths of the upper adjusting rod 20 and the lower adjusting rod 30 extending from the main body 10 are adjusted, and then the length of the lower adjusting rod 30 is further adjusted through the tensioning device 33 on the lower adjusting rod 30, to achieve precise adjustment of the height of the floor-to-ceiling pillar, such that the floor-to-ceiling pillar can be applied in different scenarios of various heights, thus further expanding an application range of the floor-to-ceiling pillar of the present disclosure.

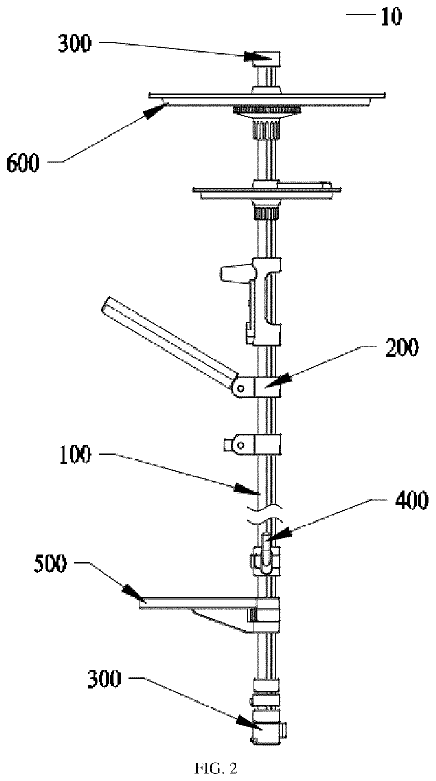

As shown in FIG. 2, the main body 10 includes a pole body 100 and electrified assemblies 200 sleeved on the pole body 100. Each of the electrified assemblies 200 is capable of sliding along the pole body 100 and rotating around the pole body 100. By supplying power to the corresponding electrified assembly 200, the present disclosure enables to charge an object hung or placed on the floor-to-ceiling pillar or illuminate an ambient environment, while having other functions. By adjusting the height of the electrified assembly 200 on the pole body 100 and a direction of the electrified assembly 200 rotating around the pole body 100, the present disclosure charges an object hung or placed on the floor-to-ceiling pillar or illuminate an ambient environment as needed. Thus, the floor-to-ceiling pillar in the present disclosure has richer functions, which can be applied to different scenarios and facilitates market promotion.

Specifically, the pole body 100 is a hollow pole, and the upper adjusting rod 20 and the lower adjusting rod 30 are respectively sleeved inside both ends of the pole body 100. The lengths of the upper adjusting rod 20 and the lower adjusting rod 30 extending from the pole body 100 are adjusted to fix the floor-to-ceiling pillar at a specific height.

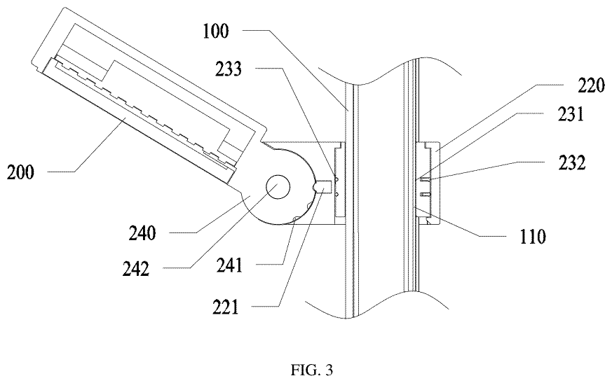

Further, as shown in FIG. 3, a conductor rail 110 is axially fixed on a surface of the pole body 100, and the conductor rail 110 is a safe low-voltage conductor rail and is electrically connected to a power supply (not shown in the figure) to supply power to the corresponding electrified assembly 200. Optionally, an end of the conductor rail 110 is fixedly connected to the length regulator 300, and a power line extends from the length regulator 300. One end of the power line is connected to the conductor rail 110, and the other end of the power line is connected to an external power supply to supply power to the corresponding electrified assembly 200 through the conductor rail 110. The conductor rail 110 connected to the power supply supplies power to all electrified assemblies 200 on the floor-to-ceiling pillar, which avoids the chaotic visual effect caused by use of separate power lines for charging electrical appliances hung or placed on the floor-to-ceiling pillar of the present disclosure, and further optimizes space utilization.

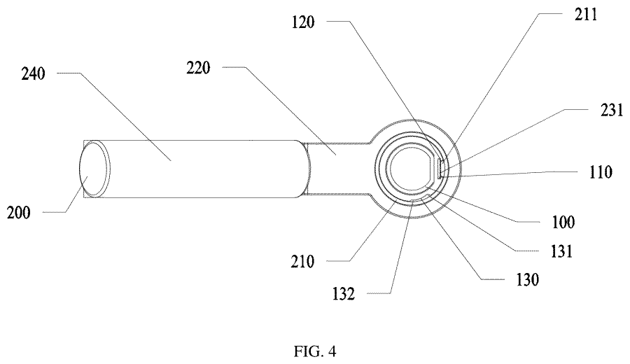

In an implementation, as shown in FIG. 4, a conductive groove 120 is axially formed on the surface of the pole body 100, and the conductor rail 110 is fixed at a bottom of the conductive groove 120. The conductive groove 120 ensures that a corresponding electrical connection component is always in correspondence and electrically connected with the conductive rail 110 when the electrified assembly 200 slides along the pole body 100, thereby achieving continuous power supply to the electrified assembly 200.

In an implementation, as shown in FIGS. 11 and 12, an electrifying part 330 is arranged on the length regulator 300 at the intersection between the lower adjusting rod 30 and the main body 10, and the electrifying part 330 is arranged on a side of the main body 10 and corresponds to the conductor rail 110 and the conductive groove 120. As shown in FIG. 13, the electrifying part 330 includes a power connector 331 and conductive sheets 332, where the power connector 331 fixes the conductive sheets 332 on the length regulator 300 and extends downwards for electrical connection with an external power supply through a power line. One end of the conductive sheet 332 is connected to the power connector 331, and the other end of the conductive sheet 332 abuts against the conductor rail 110, to transfer power received at the power connector 331 to the conductor rail 110. Preferably, a pair of the conductive sheets 332 is arranged in the electrifying part 330. In the present disclosure, the pair of the conductive sheets 332 is electrically connected to the conductor rail 110, thus ensuring continuous power supply to the electrified assembly 200 as long as the conductor rail 110 is arranged on a side of the main body 10. Optionally, the conductive sheets 332 are conductive copper sheets. In the present disclosure, through a simple structure, the electrified assemblies on the floor-to-ceiling pillar are powered without need of separate power cords for the electrified assemblies, thus facilitating assembly and storage.

In an implementation, a locking groove 130 is further axially formed on the surface of the pole body 100, and the locking groove 130 and the electrified assembly 200 match each other to achieve free sliding of the electrified assembly 200 on the pole body 100 and fix the electrified assembly 200 at a specific position on the pole body 100. Optionally, friction between the electrified assembly 200 and the locking groove 130 is adjusted to achieve free sliding of the electrified assembly 200 on the pole body 100 and fix the electrified assembly 200 at a specific position on the pole body 100, so as to fix the electrified assembly 200 at different positions of the floor-to-ceiling pillar as needed.

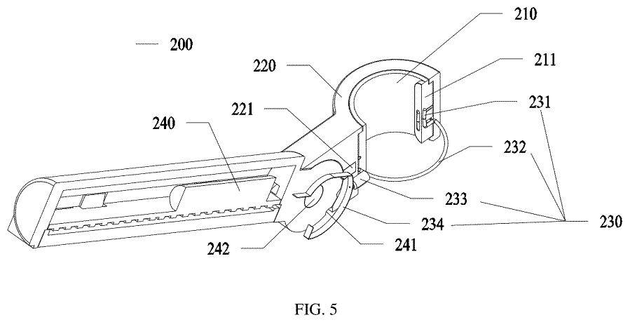

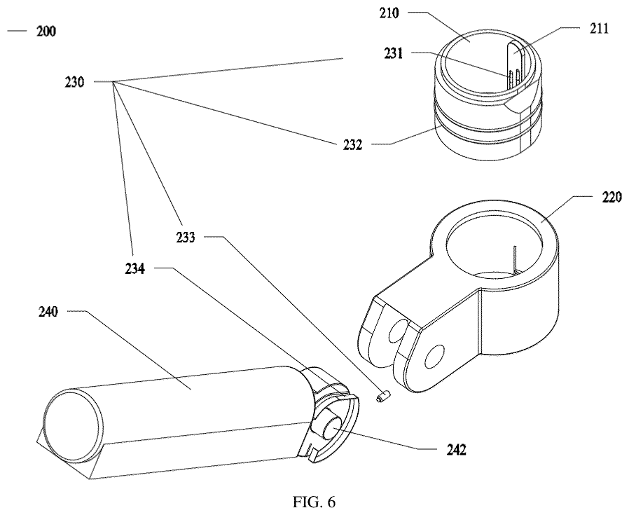

Specifically, as shown in FIGS. 5 and 6, the electrified assembly 200 includes a sliding part 210, a rotating part 220, a conductive part 230, and a power-consuming part 240. The electrified assembly 200 is sleeved on the pole body 100 and is capable of sliding along the pole body 100 and rotating around the pole body 100, thus ensuring that the electrified assembly 200 can be fixed at different height positions on the floor-to-ceiling pillar and different orientations can be adjusted, such that functions of illuminating, charging or supplying power for users at different heights and in different directions can be achieved.

In an implementation, as shown in FIG. 6, the sliding part 210 is a tubular structure corresponding to the pole body 100, and a size of an inner ring of the sliding part 210 is slightly larger than that of an outer ring of the pole body 100 to ensure that the sliding part 210 can slide freely along the pole body 100, so as to ensure that the electrified assembly 200 slides along the pole body 100 through the sliding part 210. Further, when the sliding part 210 slides along the pole body 100, the sliding part 210 does not rotate relative to the pole body 100, i.e., the sliding part 210 is arranged always in correspondence with an inner ring structure of the conductor rail 110 to ensure that when the electrified assembly 200 slides along with the sliding part 210, the conductor rail 110 always keeps electrically connected to the power-consuming part 240, so as to achieve continuous power supply to the power-consuming part 240.

In an implementation, as shown in FIG. 4, the conductive groove 120 is formed on the pole body 100, and the conductor rail is fixed inside the conductive groove 120. A boss 211 is arranged on an inner side of the sliding part 210 corresponding to the conductive groove 120, and the boss 211 matches an opening of the conductive groove 120 to clamp the boss 211 inside the conductive groove 120. A gap is formed between a surface of the boss 211 and the conductor rail 110, which avoids sliding impact caused by friction between the sliding part 210 and the conductor rail 110, and ensures that the position relationship between the sliding part 210 and the conductor rail 110 remains unchanged during sliding. Further, the boss 211 provides a positioning function for the sliding part 210. When the floor-to-ceiling pillar is assembled, it is only necessary to clamp the boss 211 correspondingly in the conductive groove 120 to ensure the position relationship between the sliding part 210 and the conductor rail 110, which is convenient, efficient, and easy to operate.

As shown in FIGS. 3 and 4, the rotating part 220 is sleeved on an outer side of the sliding part 210, and the rotating part 220 is capable of rotating around the pole body 100. Specifically, the sliding part 210 is sleeved on the pole body 100, and the rotating part 220 is sleeved on the outer side of the sliding part 210 and is capable of sliding along the pole body 100 with the sliding part 210. The position relationship between the sliding part 210 and the conductor rail 110 remains unchanged during sliding, i.e., the sliding part 210 does not rotate relative to the pole body 100 at any time, while the rotating part 220 is capable of rotating freely around the pole body 100, where the pole body 100 serves as a rotating shaft. Optionally, the size of an inner ring of the rotating part 220 is slightly larger than that of an outer ring of the sliding part 210 to facilitate free rotation of the rotating part 220. A clamping table extends inward on a top and at a bottom of the rotating part 220, and the clamping table abuts against the top and bottom of the sliding part 210 to ensure that the rotating part 220 can slide along the pole body 100 with the sliding part 210. Further, a gap is reserved between the clamping table and the pole body 100 to further ensure that the rotating part 220 is capable of rotating around the pole body 100. Specifically, after the rotating part 220 rotates to a desired angle, the position of the rotating part 220 is fixed by the friction between the clamping table and the sliding part 210, thus ensuring that the rotating part 220 is capable of rotating to any desired position on a horizontal plane by 360°.

Further, the power-consuming part 240 is fixedly connected to the rotating part 220 such that the power-consuming part 240 can slide along the pole body 100 with the rotating part 220 through the sliding part 210, freely rotate around the pole body 100 together with the rotating part 220 in the horizontal plane and be fixed at the desired angle, thus achieving the functions of illuminating, charging and supplying power for users at different heights and angles. In an implementation, as shown in FIG. 6, the power-consuming part 240 is pivotally connected to the rotating part 220 through a pivot 242, the pivot 242 is fixed at one end of the power-consuming part 240, and the power-consuming part 240 is fixedly connected to the rotating part 220 through a shaft hole formed on the rotating part 220. Optionally, the pivot 242 is horizontally arranged such that the power-consuming part 240 is capable of rotating relative to the rotating part 220 in a vertical plane, e.g., rotating from −90° to 90° in the vertical plane.

In an implementation, as shown in FIG. 3, the power-consuming part 240 is pivotally connected to the rotating part 220. To this end, a clamping tooth 221 is formed on the rotating part 220, and a plurality of clamping tooth grooves 241 corresponding to the clamping tooth 221 are formed on the power-consuming part 240, where the clamping tooth grooves 241 are meshed with the clamping tooth 221. When the power-consuming part 240 rotates relative to the rotating part 220 in the vertical plane, the clamping tooth 221 is clamped into different clamping tooth grooves 241 to fix the power-consuming part 240 at different angles in the vertical plane. Optionally, the clamping tooth 221 is an elastic clamping tooth that is capable of retracting towards the rotating part 220 when under stress, and rebounding in a direction away from the rotating part 220 when not under stress. When the power-consuming part 240 starts to rotate relative to the rotating part 220 in the vertical plane, the clamping tooth grooves 241 apply pressure on the clamping tooth 221 to retract the clamping tooth 221. When the power-consuming part 240 rotates in place, the clamping tooth 221 rebounds, extends out and is clamped with a corresponding clamping tooth groove 241, to fix the power-consuming part 240 at a corresponding position in the vertical plane. The sliding part 210 drives the electrified assembly 200 to slide along the pole body 100, such that the height of the power-consuming part 240 can be adjusted. Then the rotating part 220 drives the power-consuming part 240 to rotate around the pole body 100, such that a fixed direction of the power-consuming part 240 in the horizontal plane can be adjusted. Finally, the power-consuming part 240 rotates relative to the rotating part 220 through the pivot 242 to determine a fixed angle of the power-consuming part 240 in the vertical plane. Through use of a plurality of structures on the floor-to-ceiling pillar that match each other, functions of illuminating, charging or supplying power for users at different heights and angles and in different directions can be achieved. By placing different items at different positions, the present disclosure optimizes space utilization, expands the usage scenarios of the floor-to-ceiling pillar, and facilitates further market promotion.

Optionally, the power-consuming part 240 includes lighting fixtures, charging devices, power outlets and the like to achieve the functions of illuminating, charging or supplying power for the floor-to-ceiling pillar, which further enriches the functions of the floor-to-ceiling pillar of the present disclosure. Optionally, the power-consuming part 240 includes LED lamps, USB connectors for charging, and wireless charging trays. By adjusting the height, angle and direction of the power-consuming part 240, functions such as illuminating at a specific direction can be achieved for users. Further, adjacent power-consuming parts can be arranged in a staggered manner to further increase space utilization. Continuous power supply to the power-consuming parts expands the usage scenarios of the floor-to-ceiling pillar, and provides broader prospects for an application of the floor-to-ceiling pillar.

Further, the electrified assembly 200 continuously supplies power to the power-consuming part 240 through the conductive part 230, where one end of the conductive part 230 is arranged on a side of the sliding part 210 facing the pole body 100 and abuts against the conductor rail 110, and the other end of the conductive part 230 is electrically connected to the power-consuming part 240, thus ensuring that the power-consuming part 240 always keeps electrical connection with the conductor rail 110 even when the position of the power-consuming part 240 is adjusted, such that continuous power supply to the power-consuming part 240 is achieved. Even if the specific position, angle or direction of the power-consuming part 240 is adjusted, the working condition of the power-consuming part 240 will not be affected.

In an implementation, as shown in FIG. 5, the conductive part 230 includes a fixed convex contactor 231, a conductive wire 232, and a movable convex contactor 233, where the fixed convex contactor 231 passes through the sliding part 210 and extends and protrudes towards the pole body 100 to abut against the conductor rail 110. In an implementation, a boss 211 is arranged on the inner side of the sliding part 210 to ensure correspondence between the sliding part 210 and the conductor rail 110, i.e., the sliding part 210 does not rotate relative to the pole body 100. The fixed convex contactor 231 is fixed on a surface of the boss 211 facing the conductor rail 110 and extends and protrudes towards the conductor rail 110 to abut against the conductor rail 110. In this implementation, because the sliding part 210 is in correspondence with the conductor rail 110 through the boss 211, the fixed convex contactor 231 maintains abutment with the conductor rail 110. No matter how the height, angle or direction of the electrified assembly 200 is adjusted, the fixed convex contactor 231 always maintains abutment with the conductor rail 110, thus ensuring continuous power supply to the power-consuming part 240.

Further, one end of the conductive wire 232 passes through the sliding part 210 and is connected to the fixed convex contactor 231, and the other end of the conductive wire 232 extends from an outer side of the sliding part 210 and surrounds the outer side of the sliding part 210 by one circle to form an annular structure. The movable convex contactor 233 is fixed inside the rotating part 220 and abuts against the annular structure formed by the conductive wire 232, such that when the movable convex contactor 233 rotates around the pole body 100 together with the rotating part 220, the movable convex contactor 233 always abuts against the conductive wire 232, thus ensuring that no matter how the height, angle or direction of the electrified assembly 200 is adjusted, the conductor rail 110 continuously supplies power to the power-consuming part 240 through the conductive part 230 and the power-consuming part 240 continuously works.

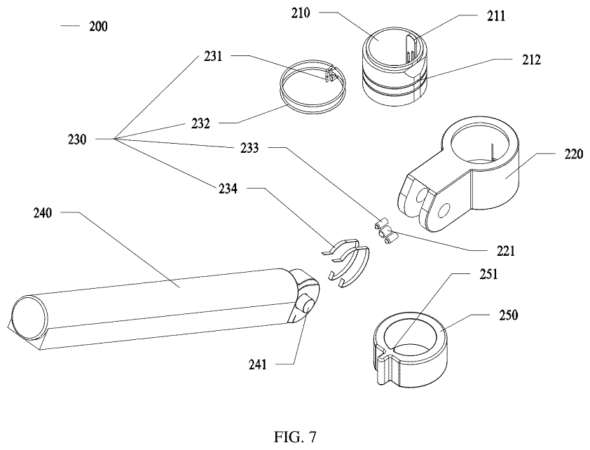

In an implementation, as shown in FIG. 7, a wire groove 212 corresponding to the conductive wire 232 is formed on an outer side wall of the sliding part 210, and the wire groove 212 surrounds the outer side of the sliding part 210 by one circle to accommodate the annular structure formed by the conductive wire 232. The conductive wire 232 is fixed inside the wire groove 212 to ensure that the conductive wire 232 remains fixed during use. Even if the movable convex contactor 233 maintains abutment with the conductive wire 232 when rotating around the pole body 100 together with the rotating part 220, the conductive wire 232 cannot be moved, thus ensuring that the power transmitted from the conductor rail 110 can be stably supplied to the power-consuming part 240 through the fixed convex contactor 231, the conductive wire 232, and the movable convex contactor 233. No matter how the height, angle or direction of the electrified assembly 200 is adjusted, the conductor rail 110 is capable of continuously supplying power to the power-consuming part 240 through the conductive part 230, thus ensuring the continuous working of the power-consuming part 240.

Further, as shown in FIGS. 5 and 7, the conductive part 230 in the floor-to-ceiling pillar of the present disclosure can further include a conductive compression spring 234, and the conductive compression spring 234 is fixed in the rotating part 220 and corresponds to the movable convex contactor 233. One end of the conductive compression spring 234 abuts against the movable convex contactor 233 to apply pressure on the movable convex contactor 233 so as to ensure that the movable convex contactor 233 abuts against the conductive wire 232; and the other end of the conductive compression spring 234 is connected to the power-consuming part 240 to transfer the power received from the conductive wire 232 by the movable convex contactor 233 to the power-consuming part 240. The conductive compression spring 234 is capable of rotating synchronously with the movable convex contactor 233 together with the rotating part 220 to ensure that pressure is applied to the movable convex contactor 233 during the rotation of the rotating part 220, thus ensuring that the movable convex contactor 233 always abuts against the conductive wire 232. In this way, when the electrified assembly 200 slides along the pole body 100 through the sliding part 210 or rotates around the pole body 100 through the rotating part 220, the conductor rail 110, the fixed convex contactor 231, the conductive wire 232, the movable convex contactor 233, the conductive compression spring 234, and the power-consuming part 240 are sequentially electrically connected to each other. No matter how the electrified assembly 200 is adjusted in the height or direction, the conductor rail 110 is capable of continuously supplying power to the power-consuming part 240 through the conductive part 230, thus ensuring the continuous working of the power-consuming part 240.

Optionally, the conductive compression spring 234 is an arc-shaped compression spring, and the clamping tooth grooves 241 matched with the power-consuming part 240 are arranged around the pivot 242, such that when the power-consuming part 240 rotates around the rotating part 220 through the pivot 242 in the vertical plane, the conductive compression spring 234 always applies pressure to the movable convex contactor to ensure that even when the angle of the electrified assembly 200 in the vertical plane is adjusted, the conductor rail 110 can continue to supply power to the power-consuming part 240 through the conductive part 230, thus ensuring the continuous working of the power-consuming part 240.

In an implementation, as shown in FIG. 7, the electrified assembly 200 further includes a locking part 250, the locking part 250 is sleeved on the pole body 100, and the locking part 250 is capable of rotating around the pole body 100. Further, the locking part 250 is arranged below the rotating part 220 and the sliding part 210, and a top end of the locking part 250 abuts against a bottom end of the rotating part 220 and the sliding part 210, such that various components in the electrified assembly 200 are capable of sliding synchronously along the pole body 100. Preferably, middle sections of the rotating part 220 and the sliding part 210 are hollow, and the locking part 250 is clamped in the hollow part of the rotating part 220 and the sliding part 210, i.e., the top end of the locking part 250 abuts against bottom ends of upper half parts of the rotating part 220 and the sliding part 210, and a bottom end of the locking part 250 abuts against top ends of lower half parts of the rotating part 220 and the sliding part 210. Therefore, when the locking part 250 can slide freely along the pole body 100, the various components in the electrified assembly 200 can synchronously slide along the pole body 100. When the locking part 250 is fixed on the pole body 100, the various components on the electrified assembly 200 are fixed on the pole body 100 through the locking part 250. Because the electrified assembly 200 is matched with the locking groove 130 formed on the pole body 100 through the locking part 250, the electrified assembly 200 slides along the pole body 100 or the electrified assembly 200 is fixed on the pole body 100, such that the position of the electrified assembly 200 on the floor-to-ceiling pillar can be adjusted, and the electrified assembly 200 can be fixed at a specific height of the floor-to-ceiling pillar.

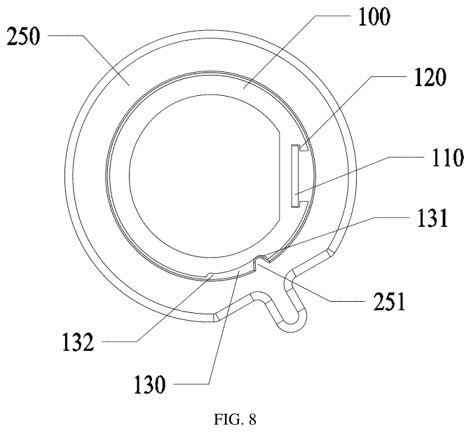

In an implementation, the locking part 250 protrudes towards the locking groove 130 to form a clamping protrusion 251. As shown in FIG. 8, the locking part 250 is provided with a first locking position 131 and a second locking position 132 in a circumferential direction of the pole body 100. A depth of the second locking position 132 is less than a depth of the first locking position 131, and the depth of the locking groove 130 gradually increases from the second locking position 132 to the first locking position 131. The depth of the second locking position 132 is less than the height of the clamping protrusion 251, and the depth of the first locking position 131 is greater than the height of the clamping protrusion 251. When the clamping protrusion 251 is located at the first locking position 131, a gap is reserved between the clamping protrusion 251 and the locking groove 130, and the locking part 250 is capable of sliding freely along the pole body 100. When the locking part 250 rotates to cause the clamping protrusion 251 to move from the first locking position 131 to the second locking position 132, the clamping protrusion 251 gradually abuts against a bottom of the locking groove 130, and the locking part 250 is fixed on the pole body 100 with an increase in the friction. Based on the position relationship between the locking part 250, the rotating part 220 and the sliding part 210, when the clamping protrusion 251 is located at the first locking position 131, the locking part 250 is separated from the pole body 100, and all components of the electrified assembly 200 are capable of sliding freely along the pole body 100. When the clamping protrusion 251 rotates to move towards the second locking position 132 together with the locking part 250, the gap between the locking part 250 and the locking groove 130 gradually increases until all components of the electrified assembly 200 are fixed at specific positions of the pole body 100, thus achieving that the electrified assembly 200 slides along the pole body 100 or the electrified assembly 200 is fixed on the pole body 100, such that the position of the electrified assembly 200 on the floor-to-ceiling pillar can be adjusted, and the electrified assembly 200 can be fixed at a specific height of the floor-to-ceiling pillar.

In another implementation, the locking part 250 is a tension button. When the locking part 250 is pressed, the locking part 250 abuts against the bottom of the locking groove 130, and the electrified assembly 200 is fixed on the pole body 100. When the locking part 250 is lifted, the locking part 250 is separated from the locking groove 130, and the electrified assembly 200 is capable of moving freely along the pole body 100, such that the position of the electrified assembly 200 on the floor-to-ceiling pillar can be adjusted, and the electrified assembly 200 can be fixed at a specific height of the floor-to-ceiling pillar.

The electrified assembly 200 in the present disclosure slides along the floor-to-ceiling pillar through the sliding part 210, and is fixed at a position in a height direction through the locking part 250. Then an orientation of the power-consuming part 240 in the horizontal plane is adjusted through the rotating part 220, and an angle of the power-consuming part 240 in the vertical plane is determined based on the rotation relationship between the power-consuming part 240 and the rotating part 220. Finally, the power-consuming part 240 is always electrically connected to the conductor rail 110 on the pole body 100 at any time through the conductive part 230, to ensure a continuous working state of the power-consuming part 240. In this way, no matter how the height, angle or direction of the electrified assembly 200 is adjusted, the floor-to-ceiling pillar of the present disclosure is capable of achieving corresponding functions of illuminating, charging or supplying power.

Optionally, as shown in FIGS. 1 and 2, the main body 10 can be further provided with hooks 400, pallets 500 and storage trays 600 that are sleeved on the pole body 100, to achieve functions of hanging or placing items on the floor-to-ceiling pillar of the present disclosure. Height positions of the hook 400, the pallet 500 and the storage tray 600 on the floor-to-ceiling pillar can be adjusted through a structure similar to the locking part 250 of the electrified assembly 200, or the states that the hook 400, the pallet 500 and the storage tray 600 freely slide and are fixed at certain positions on the floor-to-ceiling pillar can be switched through other conventional means. Specific details will not be repeated here. Further, the hooks 400 of different lengths, the pallets 500 of different sizes, and the storage trays 600 of different areas are arranged on the main body 10 of the floor-to-ceiling pillar of the present disclosure. By adjusting height differences and orientation differences between them, the present disclosure fully utilizes space, thus improving the space utilization.

To sum up, the present disclosure provides a floor-to-ceiling pillar. The floor-to-ceiling pillar includes a main body, an upper adjusting rod and a lower adjusting rod respectively sleeved inside both ends of the main body. The main body includes a pole body and electrified assemblies. The upper adjusting rod and the lower adjusting rod are respectively sleeved inside both ends of the pole body, to fix the floor-to-ceiling pillar through the upper adjusting rod and the lower adjusting rod. The electrified assemblies are sleeved on the pole body, and are capable of sliding along the pole body and are rotatably arranged around the pole body. The assemblies are electrically connected to power supplies to supply power to the power-consuming parts on the electrified assemblies. Through the arrangement of the electrified assemblies on the pole body capable of sliding freely along the pole body, in combination with the power-consuming part inside the electrified assembly, the present disclosure is capable of achieving the functions of storage, illuminating, charging, and power supply only in a small space without the need for separate power cords, which improves the aesthetics of storage. Further, height positions and orientation angles of the electrified assemblies can be adjusted freely, which further optimizes the space utilization and achieves diverse functions, such that it is more conducive to market promotion.

It should be understood that the application of the present disclosure is not limited to the above examples. For those of ordinary skill in the art, improvements or changes can be made based on the above description, all of which shall fall within the scope of protection of the claims of the present disclosure.

What is claimed is:

1. A floor-to-ceiling pillar, comprising a main body, an upper adjusting rod and a lower adjusting rod respectively sleeved inside both ends of the main body, wherein the main body comprises:
a pole body, wherein the upper adjusting rod and the lower adjusting rod are respectively sleeved inside both ends of the pole body to fix the floor-to-ceiling pillar through the upper adjusting rod and the lower adjusting rod; and
electrified assemblies, wherein the electrified assemblies are sleeved on the pole body, and are capable of sliding along the pole body and are rotatably arranged around the pole body, and the electrified assemblies are electrically connected to power supplies to supply power to the power-consuming parts on the electrified assemblies.

2. The floor-to-ceiling pillar according to claim 1, wherein a conductor rail is arranged in a way of extending in an axial direction of the pole body, and the corresponding electrified assembly is electrically connected to the power supply through the conductor rail to supply power to the power-consuming part.

3. The floor-to-ceiling pillar according to claim 2, wherein each of the electrified assemblies comprises:
a sliding part, wherein the sliding part is sleeved on the pole body, and each of the electrified assemblies slides along the pole body through the sliding part;
a rotating part, wherein the rotating part is sleeved on an outer side of the sliding part, and each of the electrified assemblies rotates around the pole body through the rotating part;
a conductive part, wherein one end of the conductive part is arranged on a side of the sliding part facing the pole body and abuts against the conductor rail, and the other end of the conductive part is electrically connected to the power-consuming part; and
the power-consuming part, wherein the power-consuming part is fixedly connected to the rotating part, and the power-consuming part is electrically connected to the conductor rail through the conductive part.

4. The floor-to-ceiling pillar according to claim 3, wherein the conductive part comprises:
a fixed convex contactor, wherein the fixed convex contactor is fixed on a side of the sliding part facing the pole body and abuts against the conductor rail;
a conductive wire, wherein the conductive wire is fixed on the sliding part, one end of the conductive wire is connected to the fixed convex contactor, and the other end of the conductive wire passes through the sliding part and surrounds the outer side of the sliding part by one circle to form an annular structure; and
a movable convex contactor, wherein the movable convex contactor is fixed inside the rotating part, and when the rotating part rotates, one end of the movable convex contactor maintains abutment with the annular structure formed by the conductive wire, and the other end of the movable convex contactor is electrically connected to the power-consuming part.

5. The floor-to-ceiling pillar according to claim 4, wherein the conductive part further comprises:
a conductive compression spring, wherein the conductive compression spring is fixed inside the power-consuming part, one end of the conductive compression spring abuts against the movable convex contactor to ensure that the movable convex contactor abuts against the conductive wire, and the other end of the conductive compression spring is connected to the power-consuming part to achieve an electrical connection between the movable convex contactor and the power-consuming part.

6. The floor-to-ceiling pillar according to claim 3, wherein the power-consuming part is pivotally connected to the rotating part, and a pivot is horizontally arranged, such that the power-consuming part is capable of rotating relative to the rotating part in a vertical plane.

7. The floor-to-ceiling pillar according to claim 6, wherein a clamping tooth is formed at a position of the rotating part facing the power-consuming part, a plurality of clamping tooth grooves corresponding to the clamping tooth are formed on the power-consuming part, and the clamping tooth grooves are meshed with the clamping tooth, to control an angle of the power-consuming part relative to the rotating part in the vertical plane.

8. The floor-to-ceiling pillar according to claim 3, wherein a conductive groove is formed on a surface of the pole body in a way of extending in an axial direction, and the conductor rail is fixed at a bottom of the conductive groove; and
in correspondence with the conductive groove, a boss is arranged on an inner side of the sliding part of each of the electrified assemblies corresponding to the conductive groove, and the boss is clamped inside the conductive groove, to ensure that the sliding part and the pole body do not rotate relative to each other when each of the electrified assemblies slides along the pole body.

9. The floor-to-ceiling pillar according to claim 3, wherein a locking groove is further formed on the surface of the pole body in a way of extending in the axial direction; and
each of the electrified assemblies further comprises a locking part, and the locking part is sleeved on the pole body and cooperates with the locking groove such that each of the electrified assemblies slides along the pole body or each of the electrified assemblies is fixed on the pole body.

10. The floor-to-ceiling pillar according to claim 9, wherein the locking groove is provided with a first locking position and a second locking position in a circumferential direction of the pole body, and a depth of the second locking position is less than a depth of the first locking position; and
the locking part is arranged below the rotating part and is capable of rotating around the pole body, and a clamping protrusion is arranged on an inner side of the locking part corresponding to the locking groove; when the clamping protrusion is located at the first locking position, the electrified assemblies are capable of sliding along the pole body, and when the locking part rotates to cause the clamping protrusion to be located at the second locking position, the electrified assemblies are fixed on the pole body.

11. The floor-to-ceiling pillar according to claim 2, wherein the main body further comprises length regulators, and the length regulators are sleeved on the main body and respectively arranged at intersections between one end of the main body and the upper adjusting rod, and between the other end of the main body and the lower adjusting rod, such that lengths of the upper adjusting rod and the lower adjusting rod extending from the main body can be adjusted.

12. The floor-to-ceiling pillar according to claim 11, wherein a plurality of inserting holes are axially formed at fixed intervals on a side of the upper adjusting rod and of the lower adjusting rod respectively, and each of the length regulators comprises:
a clamping part, wherein the clamping part is arranged to correspond to the inserting hole, and when the clamping part is clamped with the inserting hole, positions of the upper adjusting rod and the lower adjusting rod are fixed; and
a pressing part, wherein the pressing part is fixedly connected to the clamping part and arranged on opposite sides of the main body respectively; when the pressing part is pressed, the clamping part is detached from the inserting hole, and when the pressing part is released, the clamping part rebounds and is clamped with the inserting hole.

13. The floor-to-ceiling pillar according to claim 11, wherein the lower adjusting rod comprises:
a lower adjusting rod body, wherein the lower adjusting rod body is sleeved inside the main body, and a length of the lower adjusting rod body extending from the main body is adjusted by one corresponding length regulator;
an abutment plate, wherein the abutment plate is arranged at a bottom of the lower adjusting rod, to cause the floor-to-ceiling pillar to be better secured on a floor; and
a tensioning device, wherein one end of the tensioning device abuts against the abutment plate, and the other end of the tensioning device is in threaded connection to the lower adjusting rod body, such that that a thread distance between the tensioning device and the lower adjusting rod body can be adjusted by rotating the tensioning device, and the length of the lower adjusting rod extending from the main body can be further adjusted.

14. The floor-to-ceiling pillar according to claim 11, wherein an electrifying part is arranged on the length regulator at the intersection between the lower adjusting rod and the main body, and the electrifying part comprises:
conductive sheets, wherein one end of each of the conductive sheets abuts against the conductor rail; and
a power connector, wherein the power connector is connected to a power cord and electrically connected to the power supply, the other end of each of the conductive sheets is fixed on one corresponding length regulator, and the power connector transfers received power to the conductor rail through the conductive sheets, to supply power to the electrified assemblies.
